(19) United States
(12) Patent Application Publication
(10) Pub. No.: US 2004/0191411 A1
(43) Pub. Date: Sep. 30, 2004

(54) Method for making silicon carbide composites by melt infiltration

(76) Inventors: John A. Hornor, Newark, DE (US); James Dale Steibel, Mason, OH (US); Roger Lee Ken Matsumoto, Newark, DE (US); Daniel M. Domanski, Kennett Square, PA (US)

Correspondence Address: NIXON & VANDERHYE P.C./G.E., 1100 N. GLEBE RD., SUITE 800, ARLINGTON, VA, 22201, US

(21) Appl. No.: 10/401,947

(22) Filed: Mar. 31, 2003

(51) Int. Cl. B05D 3/02

(52) U.S. Cl. 427/228

(57) ABSTRACT

Process for fabricating a preform, wherein a fiber preform is infiltrated with molten silicon after being contacted with an aqueous silicon carbide particulate slurry containing a dissolved source of carbon and heated to coat the particles with carbon.

The present invention relates generally to silicon carbide composites fabricated by melt infiltration. More specifically, the present invention relates to the use of an aqueous liquid source of carbon in a silicon carbide particulate slurry to enhance infiltration of silicon into silicon carbide particulate filled silicon carbide fiber preforms. The invention may be used to produce ceramic matrix composites (CMC's) for use as shrouds, combustion liners, and nozzles of power generation gas turbines and aircraft engines.

### BACKGROUND OF THE INVENTION

In the manufacture of thin SiC particulate filled SiC fiber performs (i.e. having a thickness of 0.1″ or less), it was generally possible through the use of molten silicon infiltration to achieve a dense composite. However, when the thickness of the composites increased to greater than 0.1″, especially 0.2″ and greater, problems associated with silicon infiltration were encountered. Prior attempts to improve the infiltration of such thick composites involved adding carbon particulates to the silicon carbide particulate slurry. However, while addition of carbon particulates (e.g. carbon black) improved silicon infiltration into thicker composite parts, uninfiltrated regions were still common.

A need exists for an improved process of producing more fully densified thicker SiC fiber-reinforced preforms. The present invention seeks to meet that need.

### BRIEF DESCRIPTION OF THE INVENTION

It has been found, according to the present invention, that it is possible to increase densification of relatively thick SiC fiber-reinforced preforms, for example CVI-coated SiC preforms, by use of a liquid source of carbon, such as sugar or corn syrup, which, upon decomposition, leaves a carbon film or coating on the particles. The presence of the carbon on the particle surfaces enhances infiltration of molten silicon into the voids of the fiber preform, thereby increasing the ultimate density of the preform. The resulting increased density maximizes or increases the thermal conductivity of the preform and improves interlaminar shear strength of the composite.

In one aspect, the present invention provides a process for producing a preform, comprising contacting a fiber preform with an aqueous silicon carbide particulate slurry containing a dissolved source of carbon to coat the particles with carbon. The presence of the carbon film or residue on the particles enhances infiltration of molten silicon into the preform.

In another aspect, there is provided a preform produced according to the process of the invention.

### BRIEF DESCRIPTION OF THE DRAWINGS

FIG. 1 is a composite cast with slurry A showing incomplete infiltration of silicon into the particulate-filled matrix between fiber bundles;

FIG. 2 is a composite cast with slurry B showing complete infiltration of silicon into the particulate-filled matrix between fiber bundles;

FIG. 3 is a ZMI fiber composite cast using slurry A showing incomplete infiltration of silicon into the particulate-filled matrix;

FIG. 4 is a ZMI fiber composite cast using slurry B showing complete infiltration of silicon into the particulate-filled matrix;

FIG. 5 is a ZMI fiber composite cast using slurry C showing complete infiltration of silicon into the particulate-filled matrix.

### DETAILED DESCRIPTION OF THE INVENTION

The present invention provides a process for fabricating a fiber preform by contacting the preform with an aqueous silicon carbide particulate slurry containing a dissolved source of carbon to provide, upon decomposition of the carbon source, a coating or film of carbon on the particles. As used herein the term “source of carbon” means a compound containing carbon susceptible to decomposition, such as thermal decomposition, to deposit carbon on the surface of the particles. Typical examples of carbon sources are corn syrup or a sugar.

By use of a liquid source of carbon in the aqueous silicon carbide particulate slurry, it has been discovered that it is possible to achieve homogeneous distribution of carbon on the surfaces of the particles throughout the preform. The preform is typically heated to decompose the carbon source and deposit carbon on the particles. This, in turn, provides a wetting effect which facilitates permeation of molten silicon throughout the internal voids and spaces of the preform, and thereby produces increased densification.

The use of a liquid source of carbon has a minimal impact on processibility of the slurry. In addition, every silicon carbide particulate in the slurry is coated with a film of carbon after decomposition.

### EXAMPLES

### Example 1

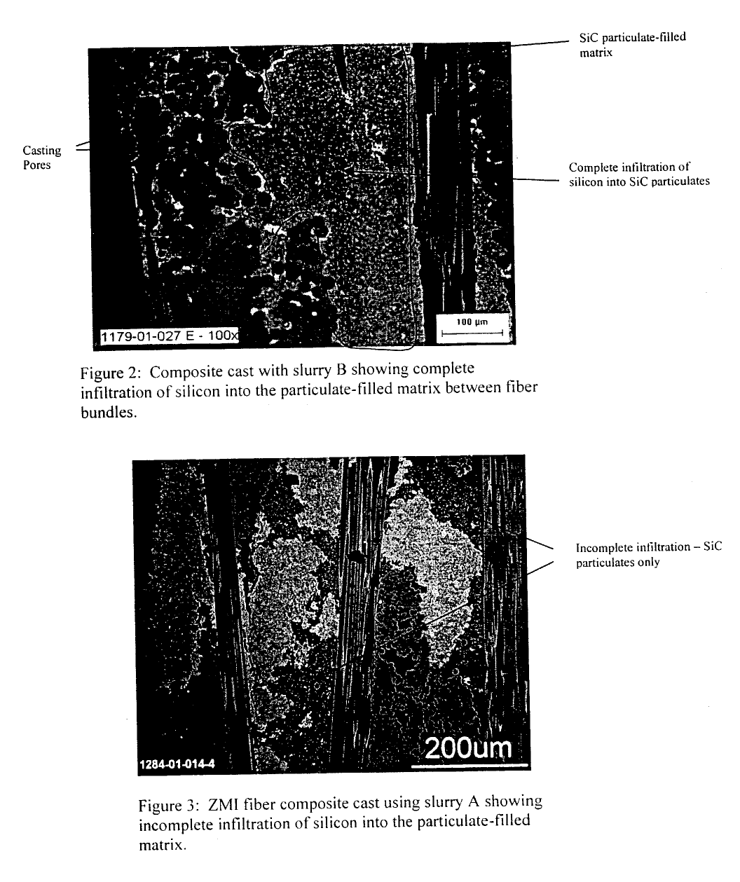

Silicon carbide slurry (composition B, see Table 1) with a liquid carbon source was prepared A 6″×2″×0.2″ SiC fiber perform and two 6″×1.5″×0.2″ performs were vacuum infiltrated with this slurry. After drying the infiltrated performs, melt infiltration was performed in a vacuum furnace using a silicon wicking procedure and both a spray and wicking procedure respectively. The resultant thicker composites had improved silicon infiltration as shown through microscopy in FIG. 2 and increased composite density than previous runs.

A counter example of incomplete infiltration is the infiltration of a 0.2″ thick CVI-coated SiC fiber (Hi-Nicalon) preform, cast using aqueous SiC particulate slurry, specifically called A. The composition of this slurry is indicated in Table 1.

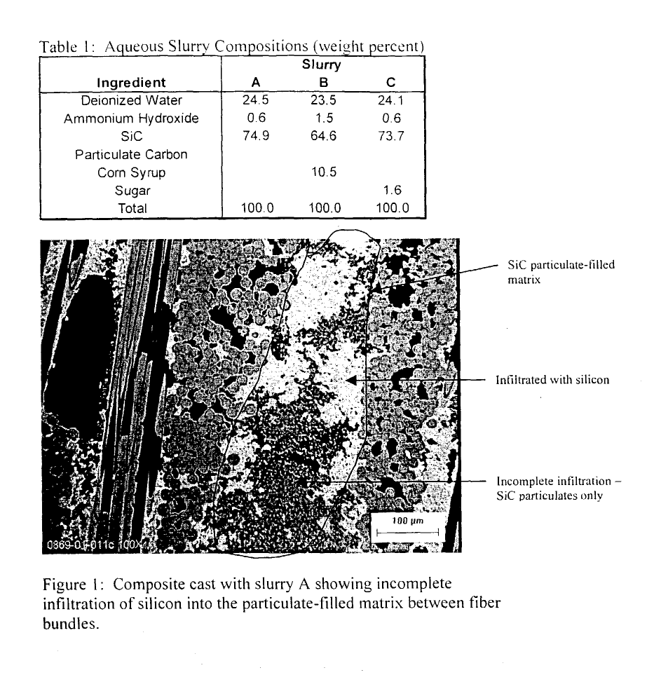

FIG. 1 shows a microstructure of the resulting composite. The infiltrated preform, has matrix areas between the fiber bundles that are predominantly filled with SiC particulates (some porosity remains). There are areas of the matrix where the silicon has infiltrated the particulates and areas where infiltration was incomplete.

FIG. 2 shows an example of a microstructure, where the infiltration of the SiC particulates of the matrix is essentially complete. The difference in this composite is that the 0.2″ thick CVI-coated Hi-Nicalon preform was cast using slurry B. As indicated in Table 1, the slurry B differs from slurry A by the addition of an aqueous source of liquid carbon, namely corn syrup. The addition of the corn syrup provides a carbon source that coats the SiC particulates. The syrup pyrolyzes during heating for the silicon infiltration process and leaves a carbon film on the particulates. This carbon source promotes reaction wetting of the particles enhancing the silicon infiltration except for large casting pores.

### Example 2

A comparison was made between silicon-infiltrated microstructures that resulted when 0.3″ thick CVI-coated SiC fiber (ZMI) preforms were cast using each of the slurry compositions indicated in Table 1. In this example, another slurry containing liquid carbon (slurry C) was developed using sugar. The sugar dissolved into the slurry during mixing of the composition. The use of the sugar rather than the corn syrup resulted in maintaining the higher solids loading of slurry.

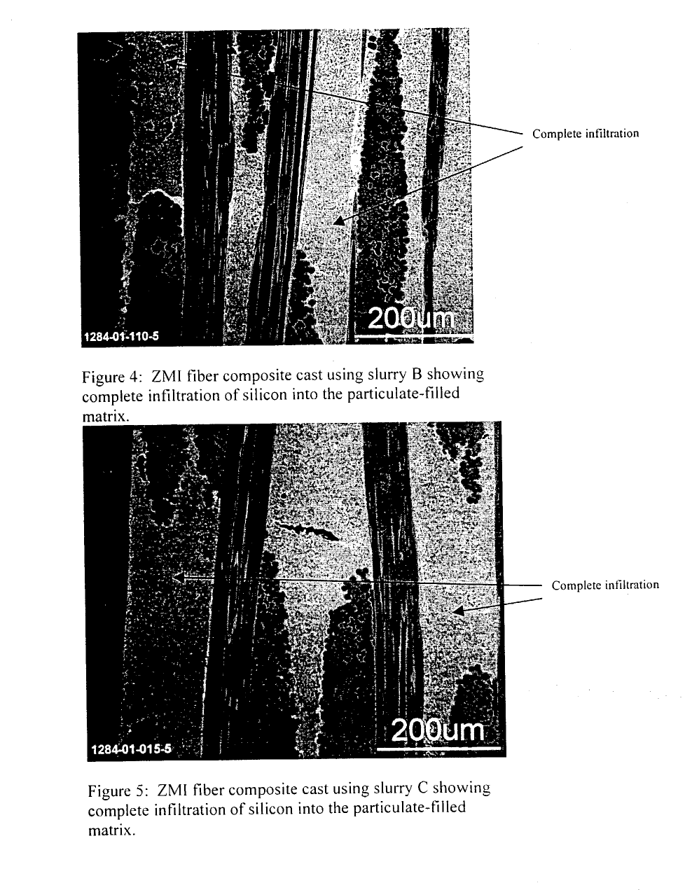

FIGS. 3, 4 and 5 show the resultant silicon infiltrated microstructures after casting with slurries A, B and C respectively. The use of slurry A again shows that incomplete infiltration of silicon into the SiC particulate matrix occurs. Changing to slurry B or C which contain an aqueous liquid carbon source results in much improved silicon infiltration. Comparison of the B and C slurries shows that more matrix cracking results during drying of slurry B because of the lower solids content. These fine matrix cracks were readily filled by the molten silicon because of the carbon content. No fine matrix cracks were observed for the composite cast with slurry C although a few larger cracks remained unfilled.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A process for producing a preform, comprising contacting a fiber preform with an aqueous silicon carbide particulate slurry containing a dissolved source of carbon to coat said particles with carbon.

2. A process according to claim 1 wherein said preform is heated to deposit carbon on the particles.

3. A process according to claim 1 wherein said source of carbon is corn syrup.

4. A process according to claim 1 wherein said source of carbon is a sugar.

5. A process according to claim 2 wherein after heating the preform molten silicon is infiltrated into the preform.

6. A composite produced by the process of claim 6.
